(19) United States
(12) Patent Application Publication
(10) Pub. No.: US 2010/0235379 A1
(43) Pub. Date: Sep. 16, 2010

(54) Web-based multimedia annotation system

(76) Inventor: Milan Blair Reichbach, Apex, NC (US)

Correspondence Address: Milan Reichbach, 1004 New Dover Road, Apex, NC, 27502, US

(21) Appl. No.: 12/454,371

(22) Filed: May 18, 2009

Related U.S. Application Data
(60) Provisional application No. 61/132,514, filed on Jun. 19, 2008.

(51) Int. Cl. G06F 15/16; G06F 17/00; G06F 17/30

(52) U.S. Cl. 707/769; 709/203; 715/233; 707/802; 707/E17.014; 707/E17.044

(57) ABSTRACT

A system that allows multimedia elements to be annotated by other multimedia and non-multimedia elements in a web based format. The multimedia elements can be video, audio, documents of different formats and any other format that may be delivered through the interne or private intranets.

### REFERENCES

| | | |
|---|---|---|
| 4,000,510 | December 1976 | Cheney, et al. |
| 4,183,056 | January 1980 | Evans, et al. |
| 4,937,685 | June 1990 | Barker, et al. |
| 5,101,364 | March 1992 | Davenport, et al. |
| 5,109,482 | April 1992 | Bohrman |
| 5,241,671 | August 1993 | Reed, et al. |

### DESCRIPTION

### Field of the Invention

The present invention relates to a system for presenting multimedia/web deliverable elements to a user and allowing the user to annotate and review the annotations for the multimedia/web deliverable elements.

### BACKGROUND OF THE INVENTION

The annotation capabilities of web based multimedia content are in their early stages. It is possible to extend the concept of a text hyperlink to entire multimedia segments using the system described in the present invention. In this manner, entire sections of audio, video and other web deliverable content become analogous to text highlighted in a hyperlink. As an example, an entire section of video can be hyperlinked to another section of, or entire, video, audio or other web deliverable entity.

### BRIEF SUMMARY OF THE INVENTION

The invention is a system that can play video and/or audio and/or other web deliverable content and allow a user to annotate these entities with annotations that are themselves multimedia (e.g., video, audio, text, URL's, documents, images, etc). The annotations can be created and/or associated during the playback of the media to be annotated. The system will allow for the media to be played back and all of the annotations will be made accessible during the playback of the media. The user will be informed during the playback of when the annotation is relevant through visual and/or audio cues such as color changes of the annotations or beeps. The relevant time frame is assigned by the person creating the annotation. The annotator can assign any time range or ranges within the media file to associate the annotations. Multiple annotations can be assigned to the same or overlapping time periods. Permissions may be assigned to allow selected groups and/or users to view various annotations thus allowing for the possibility of privileged annotations. The linkages to the annotations are contained in a database that associates the media, relevant start time and stop time to each annotation. The database is fully searchable so that users may find particular time segments of various multimedia entities that yield germane search results. This will allow users to view/hear only portions of multimedia entities that have been annotated and contain information relevant to their queries. If desired, they may view/hear the entire multimedia entity associated with a relevant annotation. Annotations that are themselves multimedia in nature may also be subsets of other full multimedia entities. In this way, relevant segments of audio and video may be linked to other relevant segments of video and audio without requiring the user to view/hear the entire multimedia annotation. Annotations can be nested infinitely deeply. In this way, just as hypertext on a web page will load another web page which itself contains hypertext, video and audio can be linked to whole or parts of other video and audio that can, in turn, link to other whole or parts of other video and audio, ad infinitum.

### DETAILED DESCRIPTION OF THE INVENTION

The present invention will now be more fully described.

The system contains both a client and a server component.

The client component comprises:
1) An interface that allows a user to interact with the multimedia/web deliverable content repository and review media as well as create, read, update and delete media and annotations from the repository. The interface will allow the user to see thumbnail images of annotations and they will be provided cues when a particular annotation or set of annotations is relevant. The annotation review section of the interface will allow a user to select, review, modify and delete annotations. The client interface is capable of interpreting metadata from the server which associates annotations with the relevant segments of the multimedia/web deliverable entities being reviewed. The client interface can interpret access control metadata from the server to allow or disallow reviewing of media by various users and groups.
2) A web browser or other client software capable of hosting the interface mentioned in client component 1.

The server component comprises:
1) A normalized database with a set of tables that allow for the storage of metadata associated with elements of the multimedia repository
2) A set of computer programs to convert multimedia elements into various formats to make them easier to transmit back to the client; the formats being dependent on the playback capabilities of the client system. This process will henceforth be referred to as transcoding.
3) A video/audio streaming server and/or a web server capable of delivering the multimedia elements to the client
4) A web server capable of delivering metadata to the client which associates annotations with the relevant segments of the multimedia/web deliverable entities being reviewed.

When the user first logs into the system they may have a completely empty repository. They can then upload a video or other multimedia/web deliverable element.

Once the element is uploaded into the repository the user can view the multimedia/web deliverable element using the player on the client side.

During the playback/review of a web deliverable multimedia element, a user can click on a control button, or in some other way initiate the annotation creation sequence.

The user will allow select the type of multimedia element that the annotation is comprised of. This may be a note, URL, video, audio, image, text document, redaction or other element. The user will then be able to assign a name to the annotation element. This name will be searchable.

The user will then be able to select the start time and end time for which this annotation is relevant. This may be accomplished by using a pair of time sliders that shift the position of the video while they are moved so that the user may see the frames (if a video) associated with the beginning and ending of the annotation. This is analogous to selecting the piece of text in a document which is used for a hyperlink.

The user will be able to enter a description of the annotation. This description will be searchable.

The user will be allowed to assign other groups and/or users access to annotations.

If the multimedia element is on the user's computer, the user will be able to browse the local file system, select the file for the annotation and upload the annotation to the server component.

If the annotation is a video, the user will be prompted to create a thumbnail of the video once the video is transcoded on the server.

The video will be displayed to the user and they will be able to review the video, select the frame of the video that will serve as the thumbnail and then have that frame be associated with this particular annotation.

Once the annotation is added, its thumbnail will be present in the annotation section of the multimedia player. If a user moves their mouse or cursor over the annotation during playback a popup window will display the metadata associated with the annotation. The user will then have the option of playing/reviewing the annotation by clicking a mouse or through some other input. The annotation will be loaded into the multimedia playback system and any annotations associated with the selected annotations will become visible in the annotation review section of the multimedia player.

These annotations in turn can themselves be annotated and reviewed ad infinitum.

The annotation section of the player will have visual and/or audio cues to allow the user to know that an annotation or set of annotations is germane at a particular time.

The annotation section of the player may move while the main media is being played/reviewed in a manner that allows for relevant annotations to be in the user's field of view. Annotations that are not currently relevant may be hidden or somehow made to be visually less important via a color change, fade or some other method.

Access control can also be embedded in the metadata for annotations. This will allow users to decide if others can see the annotations that have been created. It will also allow for groups of users to be created with various permissions.

1. A set of computer programs, residing on both a client and server, that work in concert to allow a user to play video and/or audio and/or review documents and/or other web deliverable content and allow a user of said computer programs to annotate components of the aforementioned video/audio/other content with other web deliverable content (video/audio/other) using part of or the entire web deliverable content as the annotation.

2. Means for adding, editing, viewing and deleting the annotations in claim 1.

3. A database that stores and links the annotations in a repository to the related sections of the multimedia/web deliverable contents contained in the repository.

4. Means for searching the database in claim 3 that allows the annotation to be viewed and itself be annotated with multiple annotations being allowed for each element of the repository.

5. Means of allowing annotations to be infinitely nested.

6. Means of controlling access to various media and annotations.
